(19) United States
(12) Patent Application Publication
(10) Pub. No.: US 2007/0205269 A1
(43) Pub. Date: Sep. 6, 2007

(54) METHOD AND SYSTEM FOR THE RESALE OF PREPAID CARDS AND PAPER GIFT CERTIFICATES

(76) Inventor: Mark L. Lindon, Woodland Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/681,275

(22) Filed: Mar. 2, 2007

Related U.S. Application Data
(60) Provisional application No. 60/780,042, filed on Mar. 2, 2006.

(51) Int. Cl. G06K 5/00; G06Q 40/00

(52) U.S. Cl. 235/380; 705/44

(57) ABSTRACT

A method and system for the resale of prepaid cards and paper gift certificates, which includes as part of the resale process verification of the monetary value represented by such prepaid card or gift certificate.

### CROSS-REFERENCES TO RELATED APPLICATIONS

This Application claims the benefit of U.S. Provisional Application No. 60/780,042, filed Mar. 2, 2006.

### BACKGROUND OF THE INVENTION

The present invention relates generally to the resale of items and more particularly, the resale of prepaid cards and paper gift certificates.

The merchandising public has become increasingly interested in prepaid cards and paper gift certificates with today's ever evolving marketplace. A prepaid card, also commonly referred to as a stored-value card, is typically a credit card-sized piece of plastic that contains or represents an amount of pre-loaded value. The monetary value on a prepaid card typically comes from money given to the card's issuer (or a designee) prior to its use. (Prepaid cards take many forms, including without limitation gift cards that can be used at a specific merchant or mall, travel cards that can be used in the same way as travelers' checks, payroll cards that can be used to access one's wages, “phone cards” for prepaid telephone usage and “teen cards” that are marketed to those under 18 years to access funds their parents load onto the card.) Prepaid cards frequently have a magnetic stripe and a card number that is associated with an account on a separate database (typically maintained by the card issuer or their designee), which number is used to track the monetary value associated with the account. Similarly, paper gift certificates generally have a certificate number printed on the certificate, which number is associated with a database (typically maintained by the issuer or their designee), which number is used to verify that the certificate is authentic.

In lieu of purchasing an item or specific gift for another, purchasers often elect to buy prepaid cards (including but not limited to gift cards which can be used at a merchant or shopping mall) and paper gift certificates as presents. The numerous purchasers of prepaid cards and gift certificates have acknowledged the practicability inherent in prepaid cards and gift certificates which allow the recipients of such gifts to select their own items for purchase.

However, it is not uncommon that prepaid cards and gift certificates will go unused. The recipients of these gifts may have no interest in frequenting the merchants or utilizing the services of the merchants at which the cards or certificates may be used, or may find it inconvenient to do so.

A similar problem is associated with store credit. An individual may purchase an item and then return such item, or receive a gift of an item and return such item to the merchant from which it was purchased, but the merchant from which the item was purchased may not give the individual a cash or credit card refund. Rather, such merchant may give the individual a prepaid card for a store credit which can only be used at a later time to purchase another item from such merchant. However, the recipient of the store credit may not wish to return to the merchant and purchase any of their products or services, or may find it inconvenient to do so.

Offering prepaid cards and gift certificates for resale can help to address certain problems associated with barriers to using the cards and certificates. Doing so, however, reveals other barriers, including without limitation the risk of seller fraud or seller mistake that are imposed on a resale purchaser of a prepaid card or gift certificate. Such risks are present because the purchaser must rely on the seller's assertion regarding the monetary value of the prepaid card or gift certificate without any independent verification of the monetary value represented by such item. For example, on an internet auction website, when a seller lists a prepaid card or gift certificate for sale the seller states the value thereof (i.e., the funds represented by such item available for use by the purchaser), but prospective purchasers cannot be sure of the true monetary value of such item as they do not know if the seller's assertion is correct. This barrier would be particularly significant for a business specifically set up to resell prepaid cards and gift certificates on a large scale.

Accordingly, what is needed is a method and system for the resale of prepaid cards and gift certificates by holders desiring to sell such items, that addresses the need for the validation and authentication of the monetary value of the same.

The present invention satisfies these and other needs.

### SUMMARY OF THE INVENTION

Briefly and in general terms, the present invention is directed towards a method and system for reselling prepaid cards and paper gift certificates. In one aspect, the reselling entity is provided with the capacity to verify the genuineness and value of the items being resold.

In one embodiment, the method and system of the present invention includes a holder of a prepaid card or gift certificate that interacts with a sale facilitating party or verifying party. The sale facilitating or verifying party, in turn, is configured to engage in a two way communication with the prepaid card or gift certificate issuing entity for confirming the value of the prepaid card or gift certificate. The method and system further contemplates a sale facilitating website, database or publication through which the verified resale item can be sold. Prospective buyers can engage in a transaction through the website or database or publication of the sale facilitating party or directly with the sale facilitating party. Verification can be prior to or after an item is listed for resale, and the sale facilitating party may even choose to provide the buyer with a guarantee of the monetary value of the item for sale.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a schematic block diagram representation, depicting the resale method and system of the present invention; and

FIG. 2 is a schematic block diagram representation, depicting another embodiment of a resale method and system.

### DETAILED DESCRIPTION OF THE PREFERRED EMBODIMENTS

As shown in the figures, which are provided by way of example and not limitation, the present invention is embodied in a method and system for resale of items.

In general, the verification of monetary value in the resale process can occur prior to the time that a Holder of a prepaid card or gift certificate publicly posts, lists or identifies such item for sale with, on or via a Sale Facilitating Party (such as an internet website including but not limited to an auction site, internet bulletin-board, internet classified or listing service, or an internet or print newspaper or periodical). In such an approach, the Holder submits the prepaid card or gift certificate (or an image thereof or certain information on or in the card or certificate) to the Sale Facilitating Party or a Verifying Party who contacts the issuer of the prepaid card or certificate (or its designee) and verifies the amount of funds represented by such card or gift certificate.

Such verification or the verified-status is posted with, referenced or made available in connection with the subsequent posting, listing or identifying for sale of the prepaid card or gift certificate by the Sale Facilitating Party. Alternatively, the Sale Facilitating Party or its designee may purchase the prepaid card or gift certificate prior to posting, listing or identifying it for sale, and subsequently resell it.

Alternatively, the verification of monetary value in the resale process can occur after a Holder of a prepaid card or gift certificate publicly posts, lists or identifies such item for sale with, on or via a Sale Facilitating Party (such as an internet website including but not limited to an auction site, internet bulletin-board, internet classified or listing service, or an internet or print newspaper or periodical), but before consummation of the sale thereof and payment by the purchaser (and possibly as a condition to such payment by the purchaser). In this approach, the Holder submits a prepaid card or gift certificate (or an image thereof or certain information on or in the card or certificate) to the Sale Facilitating Party or Verifying Party, for posting, listing or identifying such item for sale on or in the Sale Facilitating Party's website, database or publication. Subsequently, the prepaid card or gift certificate is posted, listed or identified for sale on or in the Sale Facilitating Party's website, database or publication. The Sale Facilitating Party or Verifying Party then contacts the Issuer of the prepaid card or gift certificate (or its designee) for verification of the amount of funds represented by such card or certificate, and the Issuer (or its designee) verifies the amount of funds. Thereafter, the verification or verified status is posted with, referenced or made available in connection with the posting, listing or identifying for sale of the prepaid card or gift certificate, or provided non-publicly to the prospective buyer(s), prior to the time payment is made to the Holder for the prepaid card or gift certificate.

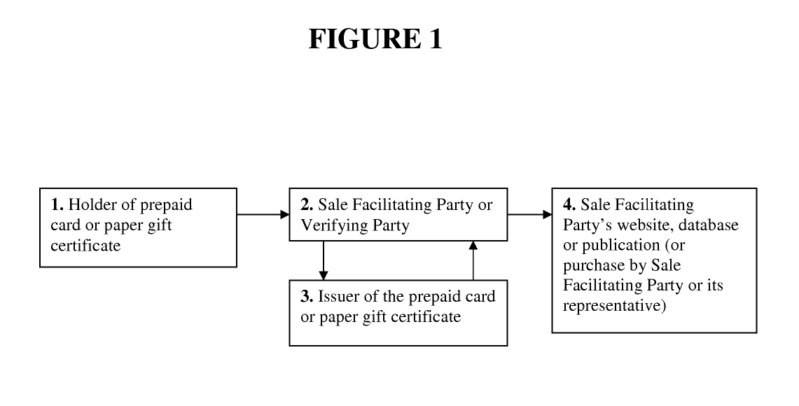

More particularly, with reference to FIG. 1, verification of a sale item can occur prior to the posting, listing or identifying for sale of a prepaid card or gift certificate by a Sale Facilitating Party on or in its website, database or publication. In a first step, the Holder submits the prepaid card or gift certificate (or an image thereof or certain information on or in the card or certificate) to the Sale Facilitating Party or Verifying Party, for verification with the Issuer of the prepaid card or gift certificate (or its designee) prior to posting the card or certificate for sale on or in the Sale Facilitating Party's website, database or publication. Next, the Sale Facilitating Party or Verifying Party contacts the Issuer of the prepaid card or gift certificate (or its designee) regarding the amount of funds represented by such card or certificate.

Thereafter, the Issuer of the prepaid card or gift certificate (or its designee) verifies to the Sale Facilitating Party or Verifying Party of the amount of funds represented by the prepaid card or gift certificate. Finally, the prepaid card or gift certificate is (a) posted, listed or identified for sale on or in the Sale Facilitating Party's website, database or publication, with the verification or verified status posted with, referenced or made available in connection with the posting, listing or identifying for sale or (b) purchased by the Sale Facilitating Party or its designee and subsequently resold.

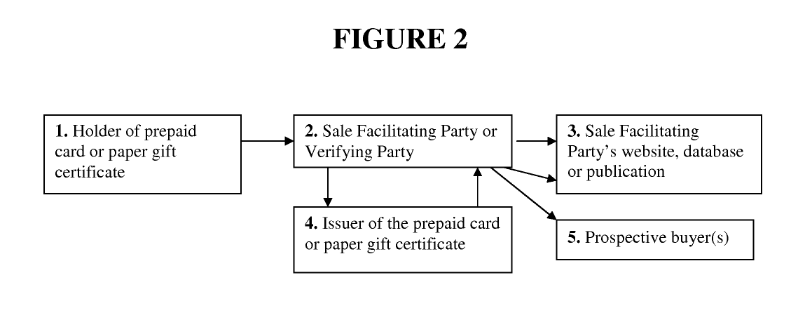

In an alternate approach, as shown in FIG. 2, verification can be obtained after the posting, listing or identifying for sale of the prepaid card or gift certificate by the Sale Facilitating Party on or in its website, database or publication (but prior to consummation of the sale and payment by the buyer). In this approach, the Holder submits a prepaid card or gift certificate (or an image thereof or certain information on or in the card or certificate) to the Sale Facilitating Party or Verifying Party, for posting, listing or identifying such item for sale on or in the Sale Facilitating Party's website, database or publication. Subsequently, the prepaid card or gift certificate is posted, listed or identified for sale on or in the Sale Facilitating Party's website, database or publication.

The Sale Facilitating Party or Verifying Party then contacts the Issuer of the prepaid card or gift certificate (or its designee) for verification of the amount of funds represented by such card or certificate, and the Issuer (or its designee) verifies the amount of funds. Thereafter, the verification or verified status is posted with, referenced or made available in connection with the posting, listing or identifying for sale of the prepaid card or gift certificate, or provided non-publicly to the prospective buyer(s), prior to the time payment is made to the Holder for the prepaid card or gift certificate.

Moreover, in one embodiment, it is contemplated that in addition to standard (unverified) listings, sellers or others can be asked to pay additional fees to have the monetary value of the card/certificate “verified” and or even “guaranteed” by the Business. Such additional services will have both additional upfront fees and higher backend fees (payable upon sale).

Sellers may be required to submit the digital images of the card/certificate or submit the card's/certificate's identification number or the actual card/certificate at the time they register an item for sale. Before a card/certificate is listed for sale, the Business (or its agent) will contact the issuer and verify the value of the card. Verification may be automated if card/certificate contains magnetic information.

Once a card/certificate has been “verified,” it will then be listed for sale with an indication of the “verified” status and the date of verification. (Note that the verification is not a guarantee that the seller thereof did not use the card after verification, but it does offer a third-party verification for buyer assurance.)

The Business may also offer sellers the option of having the card/certificate verified and “guaranteed” as authentic, providing buyers with the maximum anti-fraud assurance possible. Sellers desiring such option must send the card/certificate to the Business at the time of registration. In such event, the Business may verify the card/certificate as above but also indicate in the listing that the item is “guaranteed” by the Business. (Buyers of “guaranteed” cards/certificates will remit payment directly to the Business, which will deduct its transaction fee and pay the balance to the seller.)

Further, there may be no maximum dollar amount on “guaranteed” sales (i.e., allowing for case-by-case approval).

Additionally, the Business may carry a large Errors & Omissions Insurance policy, so that (1) enhancing prospective sellers' comfort in sending their cards/certificates to the Business for the “guaranteed” listing service and (2) prospective buyers believe the “guarantee” has economic substance. The E&O Insurance may be prominently referenced on the site's cover page and throughout.

As part of the registration process, sellers may have the opportunity to make the Business an offer to buy the card/certificate or solicit an offer from the Business, and bypass the listing and sale process. If the Business is interested and the parties agree on a price then the Business can buy those cards/certificates that it chooses and then subsequently resell them to consumers or to the issuing merchants.

It is to be further recognized that in addition to card sales covering gift cards and gift certificates, the present invention covers all prepaid value cards, including others such as store credits, phone cards, travel cards, teen cards, etc. The status of cards/certificates listed for sale (unverified, verified and guaranteed) may be identified on the main listing page, sub-listing pages, search results and all other pages showing two or more cards for sale (as well as on the detailed page describing a particular card/certificate listed for sale) either by (1) icon, letter, text or otherwise under a data field on such listing pages or (2) any other method designed to impart such information on such listing pages (including without limitation by bolding text, using different font and/or different sized font and/or different colored font and/or highlighting text otherwise) by so that prospective purchasers can easily distinguish between listed items on the basis of status (thereby distinguishing 2 otherwise identical cards).

Registration for “verified” listing above a specified monetary value may require submission of a digital image of the card/certificate. Registration for “guaranteed” listing may require actual submission of the card/certificate. Also, not every listing will necessarily automatically be “verified” or “guaranteed” and a “verified” listing is not automatically “guaranteed.” However, all “guaranteed” listings can be “verified” as part of the sale listing process.

In one aspect, “Guaranteed” listings must be requested by the user and agreed to by the Business (i.e., on a case-by-case basis), and there is no preset payment maximum in the event that a “guaranteed” card/certificate is not valid for the listed amount (i.e., unlike PayPal's maximum payment of $175 or CardAvenue's maximum payment of $90). Upon the sale of a “guaranteed” card/certificate, the Business may seek to notify the issuer of the card/certificate of the sale (to reduce the risk of fraud). This may be standard procedure if the card/certificate indicates a replacement can be obtained if the card/certificate is lost or stolen. Further, the Business may carry an actual E&O insurance to back its “guaranteed” listings.

Finally, the registration process may include an option (“sell it now”) whereby users can offer the card/certificate to the Business (and submit an offer price) or request a price/offer from the Business for the card/certificate. Additionally, the Business may seek to obtain verification databases from the major card issuers (which will be regularly updated) to allow for in-house verification against the issuers' records. Such verification may be automated. Even if such databases are not obtained and the card issuers must be contacted for each verification, such verification process may be automated. Thus, the Business can offer to sell the cards/certificates back to the issuers for below par.

Accordingly, the present invention provides a method and system for reselling prepaid cards and gift certificates which address limitations associated therewith including verifying the value of such items.

Thus, it will be apparent from the foregoing that, while particular forms of the invention have been illustrated and described, various modifications can be made without departing from the spirit and scope of the invention.

We claim:

1. A method comprising:
facilitating communication between a holder of a prepaid card or gift certificate and a sale facilitating party;
engaging in a two-way communication between the sale facilitating party and a prepaid card or gift certificate issuing entity;
confirming a value of the prepaid card or gift certificate; and
providing a mechanism by which the prepaid card or gift certificate can be sold.
